(19) United States
(12) Patent Application Publication
(10) Pub. No.: US 2010/0008461 A1
(43) Pub. Date: Jan. 14, 2010

(54) Cold fusion apparatus

(76) Inventor: John Andrew Hodgson, Safety Harbor, FL (US)

Correspondence Address: John Andrew Hodgson, P.O. Box 202, Safety Harbor, FL, 34695, US

(21) Appl. No.: 12/460,031

(22) Filed: Jul. 11, 2009

Related U.S. Application Data
(63) Continuation-in-part of application No. 11/583,546, filed on Oct. 19, 2006, now abandoned.

(51) Int. Cl. H05H 1/22; G21B 3/00

(52) U.S. Cl. 376/100; 976/DIG. 1

(57) ABSTRACT

In accordance with the present invention, this invention creates the process of cold fusion with the creation of electromagnetic scalar waves and the deuterium loading of cathode in the invention. This process of combining the deuterium loading and current flow of the cathode with the electromagnetic wave and electromagnetic scalar waves are used to allow temporary changes of the electron to electron repulsion, proton to proton repulsion Via the changing of the 3d plus linear time structure into the direction of 12d space time structure in the palladium core. Once all these conditions are met cold fusion will occur

### RELATED APPLICATIONS

The present application is a continuation-in-part application of United States provisional patent application Ser. No. 11/583,546, filed Oct. 19, 2006, for COLD FUSION APPARATUS, by John Andrew Hodgson, included by reference herein and for which benefit of the priority date is hereby claimed.

### FIELD OF THE INVENTION

The present invention relates to the process of creating low level energy fusion process and specifically the electrolytic process of creating cold fusion with electromagnetic fields.

Problems with the attempts to achieve cold nuclear fusion revolve around reproducible initiation of the process and control and propagation of the initiated reaction. To date, conditions under which one can reliably conduct a cold nuclear fusion process have not been determined. It is the purpose of the present invention to provide a process that reliably achieves cold nuclear fusion and the production of energy there from. Specifically, the present invention defines the components that can provide for initiation of the reaction and for the propagation and control of the initiated process. The present invention further provides an apparatus that produces excess heat by utilizing deuterium fusion reaction under low temperature conditions.

Other Solutions in Existence:

“A Past Experiment that was mcomplete” http://www.kryon.com/k_channeldna04.html

5372688 December 1994 Patterson

The article http://www.kryon.com/k_channeldna04.html “A past Experiment that was incomplete” Describes the process of controlled cold fusion. The description of the process requires a standard cold fusion apparatus which Ponds and Fleishman created with an additional process of adding two ultrasonic generators to the electrolytic process created with the Ponds and Fleishman apparatus to create cold fusion. This description of the ‘a past experiment that was incomplete’ process describes that a transformer created an electromagnetic field and another piece of equipment creating oscillations in the megahertz range of frequencies to create electromagnetic scalar waves which was added to the chemistry process. This article shows the basic requirements of the cold fusion process, however this included two external oscillation sources creating and transmitter of electromagnetic waves and electromagnetic scalar waves This invention is a improvement of that process by removing the two external oscillation sources and the transmission antenna describes as “One was a mild magnetic field created by a transformer and other piece of equipment creating electromagnetic waves in the process” This invention is an improvement of the process that while electromagnetic waves are mentioned. The angle of incidence of the electromagnetic fields are not described at right angles to each other in ‘a past experiment that was incomplete’ this the optimum angle of creation of electromagnetic scalar waves The invention uses the optimum angle of incidence of 90 degrees between both oscillator external coils. This invention is an improvement of the ‘A Past Experiment that was incomplete’ that the transmission antenna is combined with the electromagnetic oscillator into a single functional unit to provide a means of transmission of electromagnetic energy and creation of a electromagnetic energy in the process

U.S. Pat. No. 5,372,688 creates an unstable cold fusion reaction, this inventor tries to create an stable cold fusion reaction by the creation of palladium coated mircospheres or other metals which will form ‘metallic hydrides’ this reaction is unstable because it lacks a means of creation of stable electromagnetic scalar waves, and the U.S. Pat. No. 5,372,688 creates an cold fusion reaction only when the random electromagnetic scalar waves occur in conjunction the electrolytic cell for the production of heat energy

U.S. Pat. No. 6,024,935 shows the creation of ‘energy holes’ in the structure of the embodiments in the U.S. Pat. No. 6,024,935 thus creating cold fusion reactions, this reactions are unstable and random in origin because these embodiments have no constant electromagnetic scalar wave reactions involved in the combination of the two reactions required in the cold fusion process. The 1st process is the ‘deuterium loading of cathode structure noted in FIG. 6’ to create reductions of the atomic radii of the deuterium atoms inside the crystalline interstitial structure of the cathode the current flow created in the process of electrolytic process 2nd process is the random injection of electromagnetic scalar waves into the atomic radii of the deuterium atoms and the atomic radii of the interstitial crystalline structure of the cathode element the 2nd process is not noted in the U.S. Pat. No. 6,024,935 and lacks a means of constant injection of a stable electromagnetic scalar waves in the cathode structure noted in FIG. 6 of U.S. Pat. No. 6,024,935; or any embodiments in the U.S. Pat. No. 6,024,935

### OBJECTS OF THE INVENTION

It is therefore an object of the invention to create a source of excess heat energy.

It is another object of the invention to provide an alternative source of energy for the generation of electricity.

It is another object of the invention to provide an alternative source of energy to provide fluid pressure and air pressure via thermal induction and heat expansion.

### SUMMARY OF THE INVENTION

This invention creates the process of cold fusion with the creation of electromagnetic wave induction, electromagnetic scalar wave creation and creating a change in the time frame alteration of the region in the palladium core of this invention. This will create a temporary change of the normal barriers that separate protons from the deuterium atom from another deuterium atom, and this temporary process will create excess heat production with the fusion of deuterium into helium atoms. This is a multiphase process that when all the steps are combined in a coherent process creating cold fusion. The following pages are the summation of common forces and perceived natural laws and the process of creation of cold fusion. First is a review of electrons, magnetic, light, gravity. Then a process of inter-dimensional mixing that is involved when a mixing of frequencies are created when two electromagnetic waves are combined across a current flow of electricity and electromagnetic energies across a non linear device or in this case the cathode core of palladium

### BRIEF DESCRIPTION OF THE DRAWING

A complete understanding of the present invention may be obtained by reference to the accompanying drawings, when considered in conjunction with subsequent, detailed description, in which:

FIG. 1 number 1 is an insulated conductive wire that provides direct current power to the anode cathode FIG. 1 number 2 is the insulated conductive wire that provides current power to the anode FIG. 1 number 3 is the anode coil FIG. 1 number 4 is the cathode core.

FIG. 2 inner inductive coil FIG. 2 number 5 is the insulated electrical conductive wire providing connectivity from the outer inductive coil to the 1st oscillator tank circuit FIG. 2 number 6 is the insulated electrical conductive wire providing connectivity from the outer inductive coil to the 1st oscillator tank circuit FIG. 2 number 7 is the regular spacing of the electrical induction coil that make up the inductance portion of the oscillator tank circuit FIG. 2 number 8 is the 45 degree angle relative to the wiring of FIG. 2 number 5 and FIG. 2 number 6 FIG. 2 number 8 is also 90 degree relative to the outer inductor coil FIG. 3 number 12

FIG. 3 is a perspective view of an outer inductor coil FIG. 3 number 9 is an insulated conductive wire to provide connectivity from the outer inductive coil to the 2nd oscillator tank circuit FIG. 3 number 10 is an insulated electrical conductive wire to provide connectivity from the outer inductive coil to the 2nd oscillator tanks circuit FIG. 3 number 11 is the regular spacing of the outer inductor coil to create regular inductance for the 2nd oscillator tank circuit FIG. 3 number 12 is the 45 degree angle that the inductive outer coil is relative to the angle of the FIG. 3 number 9 insulated electrical conductive wire and FIG. 3 number 10 insulated electrical conductive wire FIG. 3 number 12 is also 90 degree relative to the inner inductor coil FIG. 2 number 8

FIG. 4 is a vessel that contains the inner and outer inductive coils with anode and cathode components with electrolyte heavy water and electrical insulated and non insulated components FIG. 4 number 13 is an insulated conductive wire that connects to the 1st oscillator tanks circuit FIG. 4 number 14 is an insulated conductive wire that connects to the 2nd oscillator tank circuit FIG. 4 number 15 is an insulated conductive wire that connects the cathode to a power source FIG. 4 number 16 is an insulated conductive wire that connects the anode to a power source FIG. 4 number 17 is an insulated conductive wire that connects the outer inductive coil to the 1st oscillator tank circuit FIG. 4 number 18 is the insulated conductive wire that connects the outer inductive coil to the 2nd oscillator tank circuit FIG. 4 number 19 is a vessel that will support the electrolyte solution and the lid for the vessel FIG. 4 number 20 is the electrolyte heavy water solution FIG. 4 number 21 is the angle of incidence of the outer inductive coil that is 45 degrees angle relative to the FIG. 4 number 18 insulated conductive wire FIG. 4 number 22 is the angle of incidence of the inner inductive coil that is 45 degrees relative to the FIG. 4 number 13 insulated conductive wire and is 90 degrees relative to the outer inductive coil FIG. 4 number 23 is the anode FIG. 4 number 24 is the cathode FIG. 4 number 25 shows the 90 degree angle of incidence of the inner and outer inductive coils FIG. 4 number 26 is the bottom of the vessel that support the lid to the vessel and the electrolyte and heavy water solution FIG. 4 number 92 is an representation of the electrolyte level that cover the inner and outer inductive coil the cathode and anode

FIG. 5 shows an vessel supporting the inductors and electrolyte solution FIG. 5 number 34 is the vessel that will provide support for the electrolyte and heavy water solution and lid FIG. 5 number 33 is the lid that will isolate the atmosphere from the electrolyte solution FIG. 5 number 32 is the insulated electrical conductive wire that connects the FIG. 4 number 18 insulated electrical conductive wire to the 2nd oscillator tank circuit FIG. 5 number 31 is the insulated electrical conductive wire to the 1st oscillator tank circuit FIG. 5 number 30 is the insulated electrical conductive that provides power to the FIG. 4 number 16 insulated electrical conductive wire FIG. 5 number 29 is the insulated electrical conductive wire that provides power to the FIG. 4 number 15 insulated electrical conductive wire FIG. 5 number 28 is the insulated electrical conductive wire that connects the FIG. 4 number 14 insulated electrical conductive wire FIG. 5 number 27 is the insulated electrical conductive wire that connects the FIG. 4 number 13 wire to the 1st oscillator tank circuit FIG. 5 number 35 is a hole in the FIG. 5 number 33 lid this hole is snug enough to prove support to the inductive outer coil inside the vessel and snug enough to seal any outside atmosphere from creating contamination to the electrolyte heavy water solution in the vessel FIG. 5 number 36 is a hole in the FIG. 5 number 33 lid this hole is snug enough to provide support to the inductive inner coil inside the vessel and snug enough to seal any outside atmosphere from creating contamination to the electrolyte heavy water solution in the vessel FIG. 5 number 37 is a hole in the FIG. 5 number 33 lid this hole is snug enough to provide support to the cathode inside the vessel and snug enough to seal any outside atmosphere from creating contamination to the electrolyte heavy water solution in the vessel FIG. 5 number 38 is a hole in the FIG. 5 number 33 lid this hole is snug enough to seal any outside atmosphere from creating contamination to the electrolyte heavy water solution in the vessel FIG. 5 number 39 is a hole in the FIG. 5 number 33 lid this hole provides support to the inner inductive coil inside the vessel this hole is also snug enough to seal outside atmosphere from creating contamination to the electrolyte heavy water solution FIG. 5 number 40 is a hole in the FIG. 5 number 33 lid this hole is snug enough to provide support to the outer inductive coil inside the vessel this hole is also snug enough to seal outside atmosphere from creating unwanted chemical reactions.

FIG. 6 is a additional embodiment of the configuration of the inductive inner and outer loops and the placement of the anode relative to the cathode FIG. 6 number 41 is the insulated electrical wire that connects the 1st oscillator tank circuit to the inner electrical inductive coil FIG. 6 number 42 is the insulated electrical wire that connects the 2 ns oscillator tanks circuit to the outer electrical inductive coil FIG. 6 number 43 is a insulated electrical wire that connects the power source to the cathode FIG. 6 number 44 is the insulated electrical conductive wire that is connected to the cathode note this arrangement places the cathode wire outside of both inner and outer inductive loop coils FIG. 6 number 45 is the electrolyte heavy water solution FIG. 6 number 44 is the anode FIG. 6 number 47 is the outer coil degree angle of incidence relative to the FIG. 6 number 46 wire FIG. 6 number 48 is the inner coil with 45 degree angle of incidence to the FIG. 6 number 41 insulated electrical wire and 90 degree relative angle of incidence to the FIG. 6 number 41 insulated electrical wire and 90 degrees relative angle of incidence to the outer electromagnetic inductive coil FIG. 6 number 50 is the cathode FIG. 6 number 51 is the 90 degree angle of incidence that is relative to the inner inductive coil loop FIG. 6 number 52 is the bottom of the vessel that supports the electrolyte heavy water solution and lid FIG. 6 number 93 is the electrolyte heavy water solution line depicting the electrolyte heavy water covering the inner and outer inductive coil and the anode and cathode components

FIG. 7 is an alternative embodiment of the inner and outer coil configuration the FIG. 7 number 55 is the inductive coil FIG. 7 number 54 is the regular spacing of the inductive coil FIG. 7 number 53 is the addition of an magnetic core to increase the electromagnetic waves being generated FIG. 7 number 94 is the insulated electrical conductive wiring that connects the inductive coil to the oscillator tank circuit FIG. 7 number 95 is an insulated electrical conductive wiring that connects the inductive coil to the oscillator tank circuit

FIG. 8 is an alternative embodiment of vessel that supports the heavy water electrolyte with oscillator cathode anode FIG. 8 number 64 is the solid state oscillator which is also 45 degree angle of incident to the FIG. 8 number 69 and FIG. 8 number 61 is the wire that support to the solid state oscillator and provides connectivity to the oscillator tank circuit FIG. 8 number 59 is an wire that provides support to the solid state oscillator and provides connectivity to the oscillator tank circuit FIG. 8 number 60 is an insulated conductive wire that provide support to the cathode FIG. 8 number 59 is an insulated conductive wire that provide support to the cathode FIG. 8 number 59 is an insulated conductive wire that provide support to the second oscillator FIG. 8 number 58 is an insulated conductive wire that provides support to the second oscillator circuit FIG. 8 number 69 is the 2nd solid state oscillator and is referenced 90 degrees to the 1st oscillator and also at an angle of incidence of 45 degrees to the FIG. 8 number 59 wire and FIG. 8 number 58 wire and is also 90 degree angle of reference to the 1sat oscillator FIG. 8 number 63 is the heavy water electrolyte solution FIG. 8 number 68 is the bottom of the vessel FIG. 8 number 56 is the cathode FIG. 8 number 70 is the anode FIG. 8 number 56 is an insulated electrical conductive wire to connect the anode to the power source

FIG. 9 is an alternative embodiment an anode inner oscillator outer oscillator electrolyte anode FIG. 9 number 71 is the anode FIG. 9 number 72 is an insulated electrical wire that connects the FIG. 9 number 71 cathode to a power source FIG. 9 number 73 is the outer oscillator FIG. 9 number 74 is the inner oscillator FIG. 9 number 75 is the cathode core FIG. 9 number 77 is an electrical insulator FIG. 9 number 78 is an electrical insulator FIG. 9 number 80 is an electrical insulator FIG. 9 number 79 is an representation of the electrolyte heavy water solution FIG. 9 number 81 is the outer oscillator core FIG. 9 number 82 is the inner oscillator core FIG. 9 number 97 is an insulated electrical wire providing power and connects to the 1st oscillator electromagnetic tank circuit FIG. 9 number 83 is an insulated electrical wire providing power and connects to the 2nd oscillating electromagnetic tank circuit FIG. 9 number 84 is the bottom of the vessel that provides support for the FIG. 5 number 33 lid and contains the electrolyte solution FIG. 9 number 180 is the cathode core also 90 degree angle of reference to the 1sat oscillator FIG. 8 number 63 is the heavy water electrolyte solution FIG. 8 number 68 is the bottom of the vessel FIG. 8 number 56 is the cathode FIG. 8 number 70 is the anode FIG. 8 number 56 is an insulated electrical conductive wire to connect the anode to the power source.

FIG. 10 is a perspective view of an alternative embodiment of inner oscillator core outer oscillator core FIG. 10 number 85 is the solid state oscillating inner core FIG. 10 number 86 shows the orientation of the oscillator electromagnetic wave produced by the solid state oscillator 32 FIG. 10 number 87 is the insulated electrical conducting wire that connects the inner solid state core to an electrical oscillating tank circuit FIG. 10 number 91 is the insulated electrical conducting wire that connects the inner solid state core to an electrical oscillation tank circuit FIG. 10 number 88 is the electrical insulator that separates the inner oscillating core to the outer oscillating core FIG. 10 number 99 is the solid state oscillating outer core FIG. 10 number 100 is the orientation of the oscillating electromagnetic wave produced by the solid state oscillator core 36 FIG. 10 number 89 is an insulated electrical conducting wire that connects the outer solid state core to an electrical oscillation tank circuit.

FIG. 11 is a perspective view of an overall construction of the cold fusion apparatus FIG. 11 number 101 is the electrical conductive wires that connect the power plug FIG. 11 number 102 to a power source FIG. 11 number 103 is the positive alternative current voltage insulated electrically conductive wire FIG. 11 number 104 is the alternative current voltage insulated electrical conductive wire FIG. 11 number 105 is the power supply assemble FIG. 11 number 106 is the power distribution module supplying power to the FIG. 11 number 107 1st oscillator 18 FIG. 11 number 108 is the 2nd oscillator FIG. 11 number 109 is the insulated electrical conductive wire connecting the 1st oscillator adjustable tank circuit to the outer inductor coil FIG. 11 number 110 is the insulated electrical conductive wire connected the 2nd oscillator adjustable tank circuit to the inner inductor coil FIG. 11 number 111 is the insulated electrical conductive wire connecting the cathode to the power supply assemble FIG. 11 number 105 FIG. 11 number 112 is the insulated electrical conductive wire connecting the anode to the power supply assemble FIG. 11 number 105 FIG. 11 number 113 is the insulated electrical conductive wire connecting the FIG. 11 number 2nd oscillator adjustable tank circuit to the inner inductor coil FIG. 11 number 114 is an insulated electrical conductive wire connecting the 1st oscillator 18 adjustable tank circuit to the outer inductor coil FIG. 11 number 115 is an hole in the FIG. 121 lid that is large enough to fit an wire though the hole and sung enough to provide isolation of the outside atmosphere air to the heavy water electrolyte solution FIG. 11 number 116 is an hole in the FIG. 121 lid that is large enough to fit an wire though the hole and sung enough to prove isolation of the outside atmosphere to the heavy water electrolyte solution FIG. 11 number 117 is an hole in the FIG. 121 lid that is large enough to fit an wire though the hole and sung enough to provide isolation of the outside atmosphere to the heavy water electrolyte solution FIG. 11 number 118 is an hole in the FIG. 121 lid that is large enough to fit an wire though the hole and sung enough to provide isolation of the outside atmosphere to the heavy water electrolyte solution FIG. 11 number 119 is an hold in the FIG. 121 lid that is large enough to fit an wire though the hole and sung enough to provide isolation of the outside atmosphere to the heavy water electrolyte solution FIG. 11 number 121 is an hold in the FIG. 121 lid that is large enough to fit an wire though the hole and sung enough to provide isolation of the outside atmosphere to the heavy water electrolyte solution FIG. 11 number 123 is the vessel that supports the lid and electrical wiring to support the components inside the vessel FIG. 11 number 124 is the adjustment that is part of the 2nd oscillator capacitors of the colpitts oscillator tank circuit FIG. 11 number 125 is the 1st adjustable oscillator tank circuit FIG. 11 number 153 is the switch that connects the power supply common ground to the 2nd oscillator tank circuit.

FIG. 12 is a perspective view of a fo the connection of the oscillator tank circuits to the inner and outer inductive coils FIG. 12 number 126 is an representation of the inner inductive coil FIG. 12 number 127 is an representation of the outer inductor coil FIG. 12 number 128 is the switch that gives common ground to the 2nd adjustable oscillator tank circuit FIG. 21 number 129 is the 2nd adjustable oscillator tanks circuit FIG. 12 number 130 is the 1st adjustable oscillator tank circuit FIG. 12 number 149 is the representation of the power supply assembly FIG. 12 number 150 is the common ground that connects to the FIG. 12 number 129 adjustable oscillator tank circuit FIG. 12 number 151 is the common ground that connects to the FIG. 12 number 130 adjustable oscillator tank circuit.

FIG. 13 is a perspective view of an of the complete setup to adjust the 1st and 2nd oscillator tank circuit FIG. 13 number 131 is the insulated electrical plug that connects the supplied power to the power supply assembly FIG. 13 number 133 FIG. 13 number 132 is the insulated electrical cord that supplies connectivity from the insulated electrical plug to the power supply assembly FIG. 13 number 133 FIG. 13 number 134 is the insulated electrical wire that connects the FIG. 13 number 133 power supply assembly to the anode in FIG. 13 number 136 vessel FIG. 13 number 135 is the tap component on the FIG. 13 number 177 electrical wire that connects the FIG. 13 number 133 power assembly 12 to the cathode in FIG. 13 number 136 vessel FIG. 132 number 137 is the oscillator scope that voltage measurement are taken off the tap circuit FIG. 13 number 135 tap.

FIG. 14 is a perspective view of a 1st oscillator 18 colpitts circuit FIG. 14 number 138 is the common ground electrical connection that is supplied from the power supply FIG. 14 number 139 si the electrical connection that is supplied from the power supply ac circuit that provides energy to heat the filament in the FIG. 14 number 147 tube FIG. 14 number 140 is the electrical connection that is supplied from the power supply ac circuit that provide energy to heat the filament in the FIG. 14 number 147 tube FIG. 141 is the electrical connection that supplies a grid voltage from the power supply to the FIG. 14 number 147 tube FIG. 142 is the electrical connection that supplies a collector voltage to the tank circuit comprising the FIG. 14 number 143 inductor and the FIG. 14 number 144 c1 adjustable capacitor FIG. 14 number 143 is the inductor coil that is in the vessel contains the inductor coil FIG. 14 number 144 is an ganged adjustable tank circuit FIG. 14 number 145 is the device that connects the FIG. 14 number 144 capacitor tank circuit and FIG. 14 number 148 adjustable capacitor FIG. 14 number 147 is the triode tube FIG. 14 number 147.

FIG. 15 is a perspective view of a power supply assembly FIG. 15 number 154 is the insulated electrical plug that connects outside supplied power to the FIG. 15 number 157 power supply assembly FIG. 15 number 155 is the electrical connection that connects the FIG. 15 number 154 electrical plus to the FIG. 15 number 156 power supply collector voltage to the 1st adjustable oscillator and 2nd adjustable oscillator FIG. 15 number 159 is the grid biasing voltage for the 2nd oscillator tube FIG. 15 number 161 is the electrical connection connecting the ac heater voltage to the 1st oscillator 18 tube FIG. 15 number 162 is the electrical connection connecting the ac heater voltage to the 1st oscillator 18 tube FIG. 15 number 178 is the electrical connection connecting the ac heater voltage to the 2nd oscillator tube FIG. 15 number 163 is the electrical connection connecting the common ground from the power supply FIG. 15 number 156 to the 1st oscillator 18 tank circuit FIG. 15 number 165 is the electrical connection connecting the common ground from the power supply from the power supply FIG. 15 number 156 to the 2nd oscillator tank circuit FIG. 15 number 164 is the switch that connects the electrical connection of the common ground to the 2nd oscillator tank circuit.

FIG. 16 is a perspective view of a 2nd oscillator colpitts circuit FIG. 16 number 166 is the common ground electrical connection that is supplied from the power supply FIG. 16 number 167 is the electrical connection that is supplied form the power supply ac circuit that provides energy to heat the filament in the FIG. 16 number 176 tube FIG. 16 number 168 is the electrical connection that is supplied from the power supply ac circuit that provide energy to heat the filament in the FIG. 16 number 176 tube FIG. 16 number 169 is the electrical connection that supplies a grid voltage from the power supply to the FIG. 16 number 176 tube FIG. 16 number 170 is the electrical connection that supplies a collector voltage to the tank circuit comprising the FIG. 16 number 171 inductor and the FIG. 16 number 172 cI adjustable capacitor FIG. 16 number 171 is the inductor coil that is in the vessel that containing the inductor coil FIG. 16 number 172 is an ganged adjustable tank circuit FIG. 16 number 173 is the device that connects the FIG. 16 number 174 adjustable capacitor and FIG. 16 number 172 adjustable capacitor FIG. 16 number 176 is the triode tube FIG. 16 number 175 is the resistor that supplies voltage bias to the emitter grid of the FIG. 15 number 176 tube.

FIG. 17 which is a perspective view of the FIG. 17 number 180 is a line that shows the oscillation path of the 1st oscillator 18; also shows the propagation of the electromagnetic wave form positive and negative e field. FIG. 17 number 181 is the electromagnetic wave form peak positive waveform. FIG. 17 number 182 is the representation of the electrical current flow along the cathode of the palladium core. FIG. 17 number 183 shows the electromagnetic wave form negative e field of the 2nd oscillator path. FIG. 17 number 184 shows the oscillation path of the 2nd oscillator, also shows the propagation of the electromagnetic wave form. FIG. 17 number 185 shows the circular region of the intersection of the 1st oscillator 18 electromagnetic wave form and the 2nd oscillator electromagnetic wave form interactions when both electromagnetic waves forms are in the same oscillation frequency and the polarities allow the beginning of electromagnetic scalar wave production. FIG. 17 number 186 shows the 90 degree relationships between both electromagnetic fields and the polarizations of positive and negative waveforms allow the nullification effects to take place. FIG. 17 number 187 shows the direction of the electromagnetic current flow along the cathode core might not have been described.

FIG. 18 which is a perspective view of the FIG. 18 number 193 shows the electromagnetic reconnection of the e field of both electromagnetic waves of the first oscillator and second oscillator electromagnetic wave form e fields negative region. FIG. 18 number 193 show the electromagnetic reconnection of the h field of both electromagnetic waves of the first oscillator and second oscillator electromagnetic wave form h field negative region. FIG. 18 number 189 of the shows the electromagnetic region of the e field of the 1st oscillator 18. FIG. 18 number 192 shows the 90 degree relationship intersection between both the 1st oscillator 18 and the second oscillator electromagnetic wave forms. FIG. 18 number 190 is the e field positive region. FIG. 18 number 191 shows the electromagnetic propagation directions. FIG. 18 number 188 shows the electromagnetic propagation directions.

FIG. 19 which is a perspective view of the FIG. 19 number 195 is the x axis of the electromagnetic wave along the propagation wave path of a oscillator wave form.

FIG. 19 number 196 shows the distribution of the e electromagnetic wave form in the oscillation wave. FIG. 19 number 190 shows the propagation of the acceleration of the electromagnetic wave form and maximum power of the oscillation wave form.

FIG. 20 which is a perspective view of the FIG. 20 number 198 is line FE=1/x2 the inverse square wave function of gravity in 3d space. FIG. 20 number 199 is the 12d space of gravity as it resides in inter-dimensional space. FIG. 20 number 200 is point B (+1,−1) and center of circle B, Circle B=propagation of gravity in region (+1,−1) with properties congruent to (+,−) on a coordinate graph as (+1,−1) FIG. 20 number 201 is the circular wave form of gravity as a engine of force. FIG. 20 number 202 is point E (+1,0) and is the intersection between photon or light and gravity FIG. 20 number 218 is the midpoint E of line AB. FIG. 20 number 203 is the x coordinate representation of 3d space and 12d space. FIG. 20 number 204 is the circular wave form of light as a engine of force. FIG. 20 number 205 is point A (+1,+1) and center of circle B, Circle B propagation of photon or light in region (+1,−1) with properties congruent to (+,+) on a coordinate graph as (+1,+1) FIG. 20 number 206 is the 12d space of light as it reside in inter-dimensional space. FIG. 20 number 208 is the line HE=1/x2 the inverse square wave function of light in 3d space. FIG. 20 number 207 is the y coordinate representation of 3d space and 12d space. FIG. 20 number 219 is point H (0,+1) the intersection of photons or light and magnetism/electromagnetism. FIG. 20 number 209 is the line HG=1/x2 inverse square wave function of magnetism/electromagnetism in 3d space. FIG. 20 number 210 is the circular wave form of electromagnetic as a engine of force. FIG. 20 number 211 is point D (−1,+1) the center of circle D, Circle D propagation of electromagnetism/magnetism in region (−1,+1) with properties congruent to (−1,+1) on a coordinate graph as (−1,+1) FIG. 20 number 212 is the 12d space of gravity as it reside inter-dimensional space. FIG. 20 number 220 is point G (−1,0) and is the intersection between electromagnetism/magnetism and time. FIG. 20 number 213 is point C (−1,−1) and center of circle C, Circle C=propagation of time in region (−1,−1), with properties congruent to (−1,−1) on a coordinate graph as (−1,−1) the center of the time center towards the circle of time propagation. FIG. 20 number 214 is the circular wave form of time as a engine of force. FIG. 20 number 215 is the 12d space of time as it resides in inter-dimensional space. FIG. 20 number 216 is the line FG=1/x2 inverse square eave function of time in 3d space. FIG. 20 number 221 is point (0,0) center of 3d space and is the (0,O) representation of a coordinate gird, with properties congruent to (+,+) in 3d space. FIG. 20 number 213 is also line CD with midpoint G at location (−1,0) FIG. 20 number 213 is also line CB with midpoint F at location (0,−1) FIG. 20 number 205 is also line AB with midpoint E at location (1,0) FIG. 20 number 205 is also line AD with midpoint H at location (0,+). FIG. 20 number 202 is also line EG with midpoint I at location (0,0). FIG. 20 number 217 is also line FH with midpoint I at location (0,0). FIG. 20 number 205 is also square ABCD and is the time frame of 3d space.

FIG. 21 number 222 is a palladium atom in a interstitial crystal structure. FIG. 21 number 223 is the representation of the repulsion of electric charge from the proton to proton and electron to electron repulsion. FIG. 21 number 224 is a palladium atom in a interstitial crystal structure. FIG. 21 number 225 is a deuterium atom in the palladium cage create from the static repulsion of electric charge. FIG. 21 number 226 is the representation of the repulsion of electric charge from the proton to proton and electron to electron repulsion. FIG. 21 number 227 is a palladium atom in a interstitial crystal structure. FIG. 21 number 228 is the representation of the repulsion of electric charge from the proton to proton and electron to electron repulsion. FIG. 211 number 229 shows the negative electron static repulsion FIG. 21 number 230 is a palladium atom in a interstitial crystal structure. FIG. 21 number 231 is the representation of the repulsion of the electric charge from the proton to proton and electron to electron repulsion. FIG. 21 number 232 is a deuterium atom in the palladium cage created from the repulsion of electric charge. FIG. 21 number 233 is the electromagnetic waveform from the 1st oscillator being injected into the electron repulsion cage. FIG. 21 number 234 is the electromagnetic waveform from the 2nd oscillator being injected into the electron repulsion cage, it also show the intersection of the 1st oscillator wave and the 2nd oscillator wave and the creation of electromagnetic scalar waves and the region that breaks down the 4d linear time frame into inter-dimensional base 12 circle time frame.

FIG. 22 which is a perspective view of the FIG. 22 number 235 is the mathematical relationship relating to gravity and magnetic with circle A light. FIG. 22 number 236 is the mathematical relationship relating to gravity and magnetic with circle C time. FIG. 22 number 237 is part of the complete formula in standard scientific notation and values with L representing light. FIG. 22 number 238 is part of the complete formula in standard scientific notation and values with T representing time. FIG. 22 number 239 is part of the complete formula in standard scientific notation and values with g representing gravity. FIG. 22 number 240 is part of the complete formula in standard scientific formula in standard scientific notation and values with B representing magnetic. FIG. 22 number 241 is light represented related to gravity and magnetic. FIG. 22 number 242 is time represented related to gravity and magnetic FIG. 22 number 243 is gravity FIG. 22 number 244 is magnetic represented related to gravity and magnetic FIG. 245 is D the circle that represents magnetic in standard scientific notations and values. FIG. 22 number 246 is circle B represents gravity in standard scientific notation and values. The mathematical relationship of FIG. 22 number 237 to FIG. 22 number 244 is the time frame in linear 3d space.

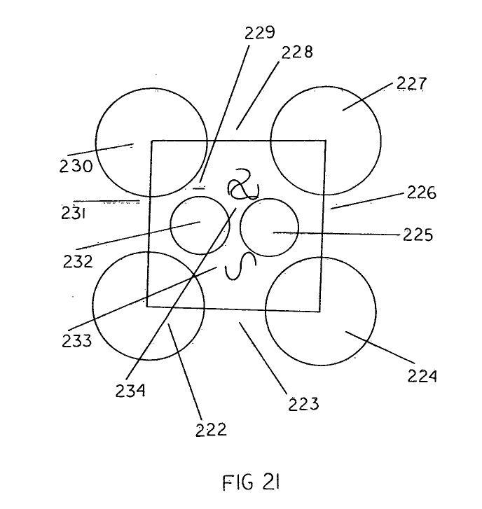

Since other modification and changes varied to fit particular operating requirements and environments will be apparent to those skilled in the art, in invention is not considered limited to the example chosen for purposes of disclosure, and covers all changes and modifications which do not constitute departures from the true spirit and scope of this invention. FIG. 21 number 222 is a palladium atom in a interstitial crystal structure. FIG. 21 number 223 is the representation of the repulsion of electric charge from the proton to proton and electron to electron repulsion. FIG. 21 number 224 is a palladium atom in a interstitial crystal structure. FIG. 21 number 225 is a deuterium atom in the palladium cage create from the static repulsion of electric charge. FIG. 21 number 226 is the representation of the repulsion of electric charge from the proton to proton and electron to electron repulsion. FIG. 21 number 227 is a palladium atom in a interstitial crystal structure. FIG. 21 number 228 is the representation of the repulsion of electric charge from the proton to proton and electron to electron repulsion. FIG. 211 number 229 shows the negative electron static repulsion FIG. 21 number 230 is a palladium atom in a interstitial crystal structure. FIG. 21 number 231 is the representation of the repulsion of the electric charge from the proton to proton and electron to electron repulsion. FIG. 21 number 232 is a deuterium atom in the palladium cage created from the repulsion of electric charge. FIG. 21 number 233 is the electromagnetic waveform from the 1^{st} oscillator being injected into the electron repulsion cage. FIG. 21 number 234 is the electromagnetic waveform from the 2^{nd} oscillator being injected into the electron repulsion cage, it also show the intersection of the 1^{st} oscillator wave and the 2^{nd} oscillator wave and the creation of electromagnetic scalar waves and the region that breaks down the 4d linear time frame into inter-dimensional base 12 circle time frame.

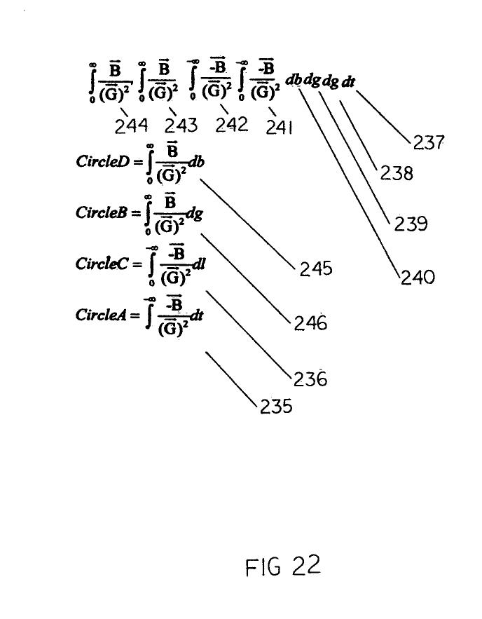

FIG. 22 number 235 is the mathematical relationship relating to gravity and magnetic with circle A light. FIG. 22 number 236 is the mathematical relationship relating to gravity and magnetic with circle C time. FIG. 22 number 237 is part of the complete formula in standard scientific notation and values with L representing light. FIG. 22 number 238 is part of the complete formula in standard scientific notation and values with T representing time. FIG. 22 number 239 is part of the complete formula in standard scientific notation and values with g representing gravity. FIG. 22 number 240 is part of the complete formula in standard scientific formula in standard scientific notation and values with B representing magnetic. FIG. 22 number 241 is light represented related to gravity and magnetic. FIG. 22 number 242 is time represented related to gravity and magnetic FIG. 22 number 243 is gravity FIG. 22 number 244 is magnetic represented related to gravity and magnetic FIG. 245 is D the circle that represents magnetic in standard scientific notations and values. FIG. 22 number 246 is circle B represents gravity in standard scientific notation and values. The mathematical relationship of FIG. 22 number 237 to FIG. 22 number 244 is the time frame in linear 3d space.

### DETAILED OPERATION OF THE COLD FUSION APPARATUS

This invention creates the process of cold fusion with the creation of electromagnetic wave induction, electromagnetic scalar wave creation and creating a change in the time frame alteration of the region in the palladium core of this invention. This will create a temporary change of the normal barriers that separate protons from the deuterium atom from another deuterium atom, and this temporary process will create excess heat production with the fusion of deuterium into helium atoms. This is a multiphase process that when all the steps are combined in a coherent process creating cold fusion. The following pages are the summation of common forces and perceived natural laws and the process of creation of cold fusion. First is a review of electrons, magnetic, light, gravity.

The relationship of electrons and inverse square law applies to many areas of study is a proof that electron spins in and out. Let electron spin in be the sum of coefficient of a quadric equation that is equaled to 2b. Let electron spin out be the sum of coefficient of a quadric equation that is equaled to 0. At x=0 those two quadric will intersect in one point. The factor of r is the point of intersection between those two quadric equations. Electron spin in and Electron spin out exist in the curvature of space at one point. This point is the factor of r that we see in the inverse square formula of light, gravity, electric, and radiation.

ax²+bx+c

a+b+c=kn!

a+b+c=kn(n−1)

a+b+c=k(n²−n)

a+b+c=k(n²−n) n=\sqrt{n} and n=−\sqrt{n}
electron spin in and electron spin out is controlled by factorial because it is based on probability.

a+b+c=k(b−e)

a+b+c=k(b−0)electron spin in

a+b+c=kb

a+b+c=−e(b+k)

a+b+c=0(b+k)electron spin out

a+b+c=0

Electron Spin(ax²+bx+c)r with x=0
In space, Electron Spin in=Electron Spin out
A electron spin in quadric is a factor of r at x=0.
A electron spin in quadric have the sum of its coeffient equal 2b.
If ax²+bx+c is a electron spin in then a+b+c=2b.

x²+2x+1

a+b+c=2b
r factor is 1

x²+3x+2

a+b+c=2b
r factor is 2

x²+4x+3

a+b+c=−2b
r factor is 3
A electron spin out quadric is a factor of r at x=0.
A electron spin out quadric have the sum of its coeffient equal 0.
If ax²+bx+c is a electron spin out then a+b+c=0.

x²−2x+1

a+b+c=0
r factor is 1

x²−3x+2

a+b+c=0.
r factor is 2

x²−4x+3

a+b+c=0
r factor is 3

The factor r will follow the same pattern than spiral number. All spiral numbers greater than zero have two quadric equations, one for the electron spin in and one for the electron spin out. Inverse Square Law, Light; Inverse Square Law, Gravity; Inverse Square law, electric; Inverse square law, radiation. The source of All spiral numbers greater than zero have two quadric equations, one for the electron spin in and one for the electron spin out.

Inverse Square Law, Light; Inverse Square Law, Gravity; Inverse Square law, electric; Inverse square law, radiation. The source of the electron spin in and spin out is connected to inverse square and spiral number. The two quadric equations is a proof to support this reality.

The inverse of α shows this relationships with inverse square law.

$$α = \frac{{e}^{2}}{4 π {ɛ}_{0} ℏ c} = \frac{1}{137}$$

$$\frac{1}{α} = \frac{4 π {ɛ}_{0} ℏ c}{{e}^{- 2}} = 137$$

The inverse of rₑ shows this relationships with inverse square law.

$${r}_{e} = \frac{{e}^{2}}{4 π {ɛ}_{0} {m}_{e} {c}^{2}}$$

$$\frac{1}{{r}_{e}} = \frac{4 π {ɛ}_{0} {m}_{e} {c}^{2}}{{e}^{2}}$$

electron radius

The importance of the number 137 is that it is related to the so-called ‘fine-structure constant’ of quantum electrodynamics. This derived quantity is given by combining several fundamental constants of nature:

where e is the charge on the electron, c is the speed of light, h-bar is Planck's constant and the epsilon represents the permittivity of free space. Despite the fact that each of these constants have their own dimensions, the fine-structure constant is completely dimensionless!

The importance of the constant is that it measures the strength of the electromagnetic interaction. It is precisely because the constant is so small (i.e. 1/137 as opposed to ⅓ or 5 or 100 . . . ) that quantum electrodynamics (QED) works so amazingly well as a quantum theory of electromagnetism. It means that when we go to calculate simple processes, such as two electrons scattering off one another through the exchange of photons, we only need to consider the simple case of one photon exchange—every additional photon you consider is less important by a factor of 1/137. This is why theorists have been so successful at making incredibly accurate predictions using QED. By contrast, the equivalent ‘fine-structure’ constant for the theory of strong interactions (quantum chromo dynamics or QCD) is just about 1 at laboratory energy scales. This makes calculating things in QCD much, much more involved.

It is worth noting that the fine-structure ‘constant’ isn't really a constant. The effective electric charge of the electron actually varies slightly with energy so the constant changes a bit depending on the energy scale at which you perform your experiment. For example, 1/137 is its value when you do an experiment at very low energies (like Millikan's oil drop experiment) but for experiments at large particle-accelerator energies its value grows to 1/128.

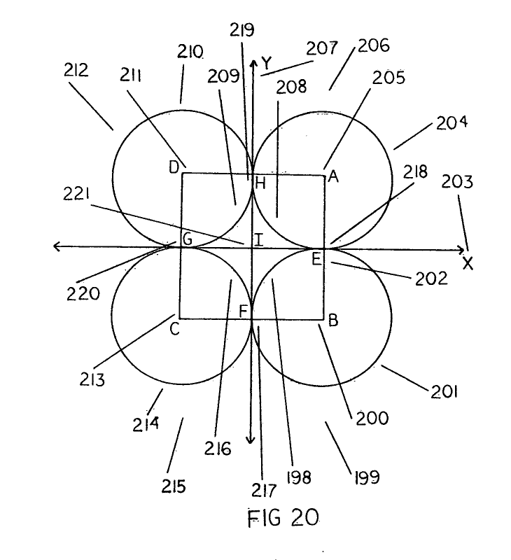

This portion of the detailed operation of the Cold Fusion Apparatus is the usage of the electromagnetic waves and the actual process of non linear mixing of frequencies. This is actually a process of inter-dimensional mixing that is involved when a mixing of frequencies are created when two electromagnetic waves are combined across a current flow of electricity and electromagnetic energies across a non linear device or in this case the cathode core of palladium. The final property involved is something called linear time and linear space. In 3d space there is added a 4th component called time, and the mystery is why is space linear and time only a positive quality in 3d space. The model of the four properties of 3d space time shows that gravity, time, magnetic, light are inverse square laws and when combined they create a linear time frame and this is a stable field when all the properties remain as inverse square law, this time frame can be changed when the scalar wave mechanics are involved with electromagnetic fields nullify each other and destabilize the time frame, as FIG. 20 shows once the time frame destabilizes, the time curls back into a circle thus changing the property of time and changing the distances of particles creating compression of the deuterium atoms, time is changed and also distance is changed, this also changes the value of gravity and light and time. The most effective means of creating these changes in the time frame are the 90 degrees angles in reference to each other circles, this is the best means to have different effects of time frames. Currently nearly all physics are using kinetics to change values and measure values of matter and charges. This process uses vibration and oscillations to change those values instead of kinetics. FIG. 22 shows the relationships of time, magnetic, gravity and light relationship in a 3d timeframe in linear space.

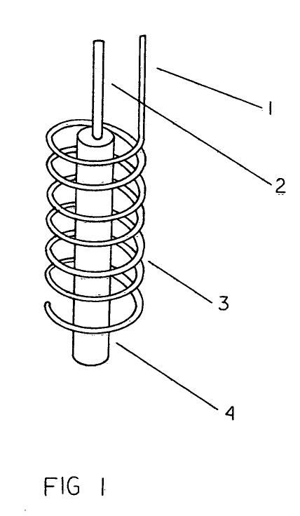

FIG. 1 is a perspective view of a FIG. 1 number 1 is an insulated conductive wire that provides direct current power to the anode cathode FIG. 1 number 2 is the insulated conductive wire that provides current power to the anode FIG. 1 number 3 is the anode coil FIG. 1 number 4 is the cathode core.

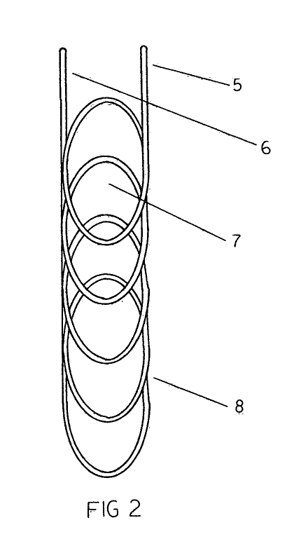

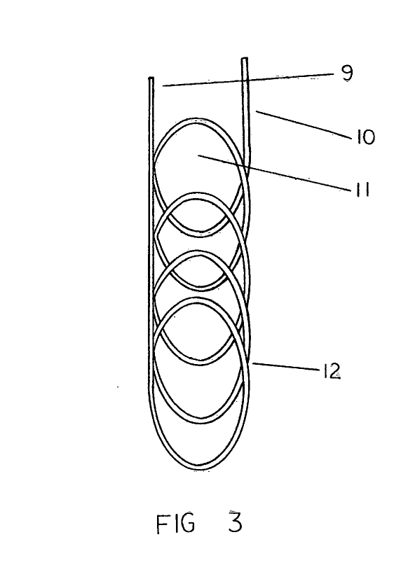

FIG. 2 is a perspective view of an inner inductive coil FIG. 2 number 5 is the insulated electrical conductive wire providing connectivity from the outer inductive coil to the 1st oscillator 18 tank circuit FIG. 2 number 6 is the insulated electrical conductive wire providing connectivity from the outer inductive coil to the 1st oscillator 18 tank circuit FIG. 2 number 7 is the regular spacing of the electrical induction coil that make up the inductance portion of the oscillator tank circuit FIG. 2 number 8 is the 45 degree angle relative to the wiring of FIG. 2 number 5 and FIG. 2 number 6 FIG. 2 number 8 is also 90 degree relative to the outer inductor coil FIG. 3 number 12.

FIG. 3 is a perspective view of an outer inductor coil FIG. 3 number 9 is an insulated conductive wire to provide connectivity from the outer inductive coil to the 2nd oscillator tank circuit FIG. 3 number 10 is an insulated electrical conductive wire to provide connectivity from the outer inductive coil to the 2nd oscillator tanks circuit FIG. 3 number 11 is the regular spacing of the outer inductor coil to create regular inductance for the 2nd oscillator tank circuit FIG. 3 number 12 is the 45 degree angle that the inductive outer coil is relative to the angle of the FIG. 3 number 9 insulated electrical conductive wire and FIG. 3 number 10 insulated electrical conductive wire FIG. 3 number 12 is also 90 degree relative to the inner inductor coil FIG. 2 number 8.

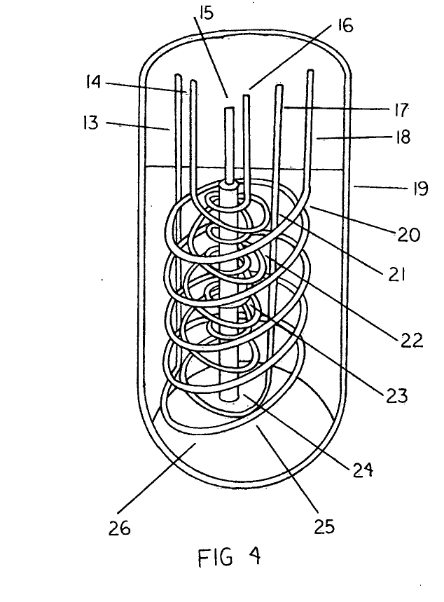

FIG. 4 is a perspective view of a vessel that contains the inner and outer inductive coils with anode and cathode components with electrolyte heavy water and electrical insulated and non insulated components FIG. 4 number 13 is an insulated conductive wire that connects to the 1st oscillator 18 tanks circuit FIG. 4 number 14 is an insulated conductive wire that connects to the 2nd oscillator tank circuit FIG. 4 number 15 is an insulated conductive wire that connects the cathode to a power source FIG. 4 number 16 is an insulated conductive wire that connects the anode to a power source FIG. 4 number 17 is an insulated conductive wire that connects the outer inductive coil to the 1st oscillator 18 tank circuit FIG. 4 number 18 is the insulated conductive wire that connects the outer inductive coil to the 2nd oscillator tank circuit FIG. 4 number 19 is a vessel that will support the electrolyte solution and the lid for the vessel FIG. 4 number 20 is the electrolyte heavy water solution FIG. 4 number 21 si the angle of incidence of the outer inductive coil that is 45 degrees angle relative to the FIG. 4 number 18 insulated conductive wire FIG. 4 number 22 is the angle of incidence of the inner inductive coil that is 45 degrees relative to the FIG. 4 number 13 insulated conductive wire and is 90 degrees relative to the outer inductive coil FIG. 4 number 23 is the anode FIG. 4 number 24 is the cathode FIG. 4 number 25 shows the 90 degree angle of incidence of the inner and outer inductive coils. FIG. 4 number 26 is the bottom of the vessel that support the lid to the vessel and the electrolyte and heavy water solution FIG. 4 number 92 is an representation of the electrolyte level that cover the inner and outer inductive coil the cathode and anode.

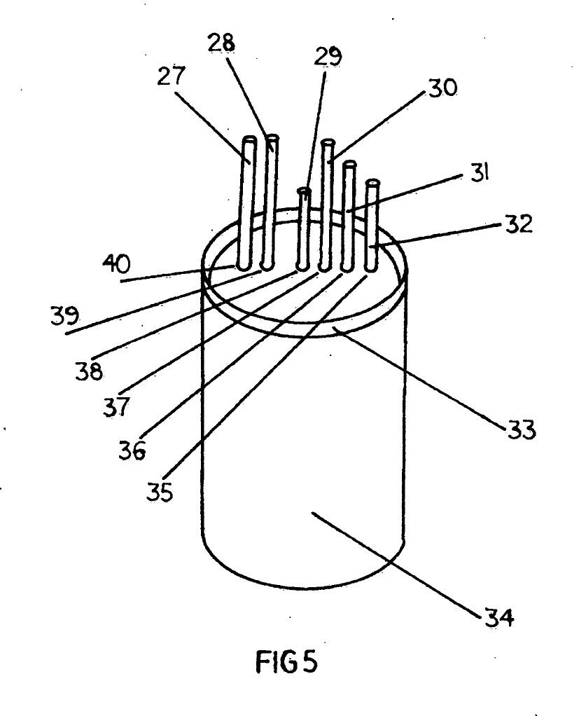

FIG. 5 is a perspective view of a vessel lid holes wires FIG. 5 number 34 is the vessel that will prove support for the electrolyte and heavy water solution and lid FIG. 5 number 33 is the lid that will isolate the atmosphere from the electrolyte solution FIG. 5 number 32 is the insulated electrical conductive wire that connects the FIG. 4 number 18 insulated electrical conductive wire to the 2nd oscillator tank circuit FIG. 5 number 31 is the insulated electrical conductive wire to the 1st oscillator 18 tank circuit FIG. 5 number 30 is the insulated electrical conductive that provides power to the FIG. 4 number 16 insulated electrical conductive wire FIG. 5 number 29 is the insulated electrical conductive wire that provides power to the FIG. 4 number 15 insulated electrical conductive wire FIG. 5 number 28 is the insulated electrical conductive wire that connects the FIG. 4 number 14 insulated electrical conductive wire FIG. 5 number 27 is the insulated electrical conductive wire that connects the FIG. 4 number 13 wire to the 1st oscillator tank circuit FIG. 5 number 35 is a hole in the FIG. 5 number 33 lid this hole is snug enough to prove support to the inductive outer coil inside the vessel and snug enough to seal any outside atmosphere from creating contamination to the electrolyte heavy water solution in the vessel FIG. 5 number 36 is a hole in the FIG. 5 number 33 lid this hole is snug enough to provide support to the inductive inner coil inside the vessel and snug enough to seal any outside atmosphere from creating contamination to the electrolyte heavy water solution in the vessel FIG. 5 number 37 is a hole in the FIG. 5 number 33 lid this hole is snug enough to provide support to the cathode inside the vessel and snug enough to seal any outside atmosphere from creating contamination to the electrolyte heavy water solution in the vessel FIG. 5 number 38 is a hole in the FIG. 5 number 33 lid this hole is snug enough to seal any outside atmosphere from creating contamination to the electrolyte heavy water solution in the vessel FIG. 5 number 39 is a hole in the FIG. 5 number 33 lid this hole provides support to the inner inductive coil inside the vessel this hole is also snug enough to seal outside atmosphere from creating contamination to the electrolyte heavy water solution FIG. 5 number 40 is a hole in the FIG. 5 number 33 lid this hole is snug enough to provide support to the outer inductive coil inside the vessel this hole is also snug enough to seal outside atmosphere from creating contamination to the electrolyte heavy water solution.

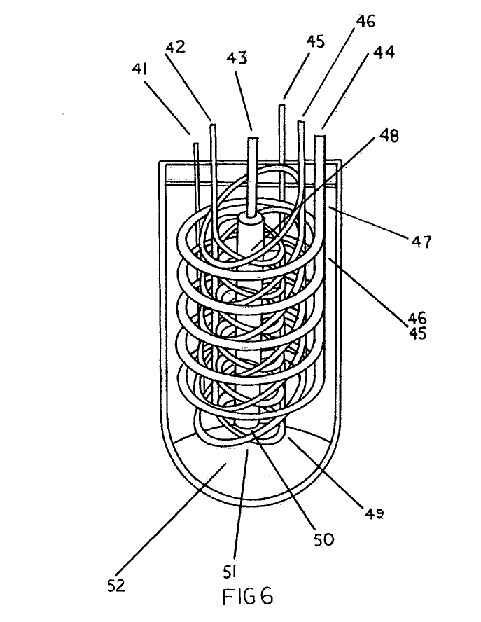

FIG. 6 is a perspective view of an additional embodiment of the reconfiguration of the inductive inner and outer loops and the placement of the anode relative to the cathode FIG. 6 number 41 is the insulated electrical wire that connects the 1st oscillator 18 tank circuit to the inner electrical inductive coil FIG. 6 number 42 is the insulated electrical wire that connects the 2 ns oscillator tanks circuit to the outer electrical inductive coil FIG. 6 number 43 is a insulated electrical wire that connects the power source to the cathode FIG. 6 number 44 is the insulated electrical conductive wire that is connected to the cathode note this arrangement places the cathode wire outside of both inner and outer inductive loop coils FIG. 6 number 45 is the electrolyte heavy water solution FIG. 6 number 44 is the anode FIG. 6 number 47 is the outer coil degree angle of incidence relative to the FIG. 6 number 46 wire FIG. 6 number 48 is the inner coil with 45 degree angle of incidence to the FIG. 6 number 41 insulated electrical wire and 90 degree relative angle of incidence to the FIG. 6 number 41 insulated electrical wire and 90 degrees relative angle of incidence to the outer electromagnetic inductive coil FIG. 6 number 50 is the cathode FIG. 6 number 51 is the 90 degree angle of incidence that is relative to the inner inductive coil loop FIG. 6 number 52 is the bottom of the vessel that supports the electrolyte heavy water solution and lid FIG. 6 number 93 is the electrolyte heavy water solution line depicting the electrolyte heavy water covering the inner and outer inductive coil and the anode and cathode components.

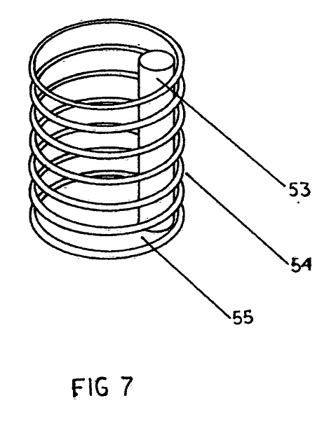

FIG. 7 is a perspective view of an alternative embodiment of the inner and outer coil configuration the FIG. 7 number 55 is the inductive coil FIG. 7 number 54 is the regular spacing of the inductive coil FIG. 7 number 53 is the addition of an magnetic core to increase the electromagnetic waves being generated FIG. 7 number 94 is the insulated electrical conductive wiring that connects the inductive coil to the oscillator tank circuit FIG. 7 number 95 is an insulated electrical conductive wiring that connects the inductive coil to the oscillator tank circuit.

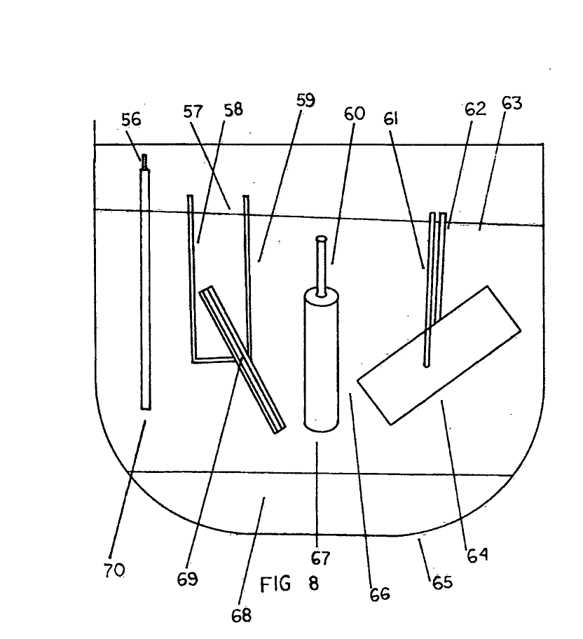

FIG. 8 is a perspective view of an alternative embodiment of vessel that supports the heavy water electrolyte with oscillator cathode anode FIG. 8 number 64 is the solid state oscillator 32 which is also 45 degree angle of incident to the FIG. 8 number 69 and FIG. 8 number 61 is the wire that support to the solid state oscillator 32 and provides connectivity to the oscillator tank circuit FIG. 8 number 59 is an wire that provides support to the solid state oscillator 32 and provides connectivity to the oscillator tank circuit FIG. 8 number 60 is an insulated conductive wire that provide support to the cathode FIG. 8 number 59 is an insulated conductive wire that provide support to the cathode FIG. 8 number 59 is an insulated conductive wire that provide support to the second oscillator FIG. 8 number 58 is an insulated conductive wire that provides support to the second oscillator circuit FIG. 8 number 69 is the 2nd solid state oscillator 32 and is referenced 90 degrees to the 1st oscillator 18 and also at an angle of incidence of 45 degrees to the FIG. 8 number 59 wire and FIG. 8 number 58 wire and is also 90 degree angle of reference to the 1sat oscillator FIG. 8 number 63 is the heavy water electrolyte solution FIG. 8 number 68 is the bottom of the vessel FIG. 8 number 56 is the cathode FIG. 8 number 70 is the anode FIG. 8 number 56 is an insulated electrical conductive wire to connect the anode to the power source.

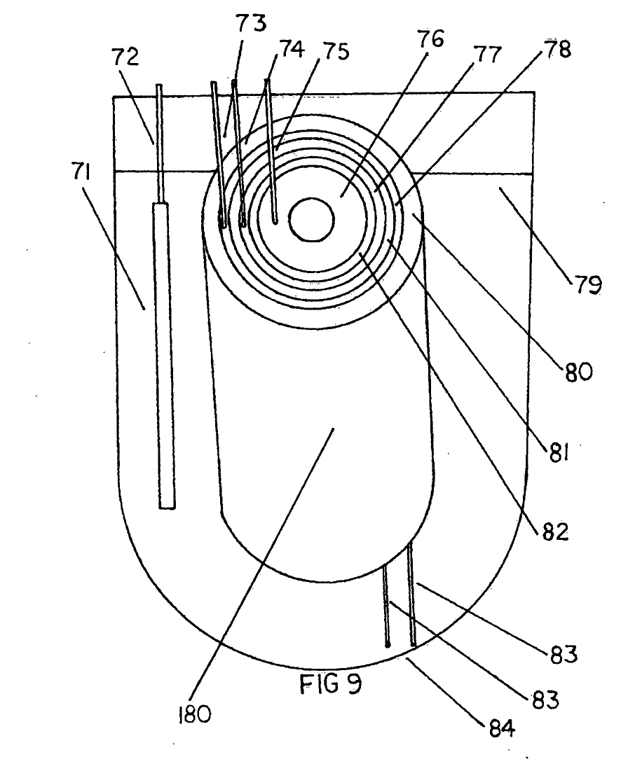

FIG. 9 is a perspective view of an alternative embodiment an anode inner oscillator outer oscillator electrolyte anode FIG. 9 number 71 is the anode FIG. 9 number 72 is an insulated electrical wire that connects the FIG. 9 number 71 cathode to a power source FIG. 9 number 73 is the outer oscillator FIG. 9 number 74 is the inner oscillator FIG. 9 number 75 is the cathode core FIG. 9 number 77 is an electrical insulator FIG. 9 number 78 is an electrical insulator FIG. 9 number 80 is an electrical insulator FIG. 9 number 79 is an representation of the electrolyte heavy water solution FIG. 9 number 81 is the outer oscillator core FIG. 9 number 82 is the inner oscillator core FIG. 9 number 97 is an insulated electrical wire providing power and connects to the 1st oscillator 18 electromagnetic tank circuit FIG. 9 number 83 is an insulated electrical wire providing power and connects to the 2nd oscillating electromagnetic tank circuit FIG. 9 number 84 is the bottom of the vessel that provides support for the FIG. 5 number 33 lid and contains the electrolyte solution FIG. 9 number 180 is the cathode core.

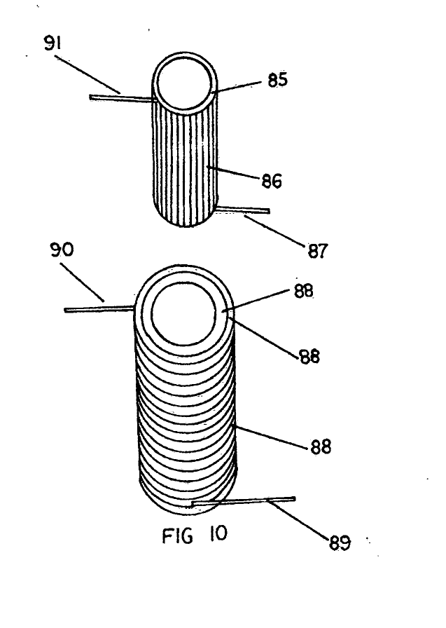

FIG. 10 is a perspective view of an alternative embodiment of inner oscillator core outer oscillator core FIG. 10 number 85 is the solid state oscillating inner core FIG. 10 number 86 shows the orientation of the oscillator electromagnetic wave produced by the solid state oscillator 32 FIG. 10 number 87 is the insulated electrical conducting wire that connects the inner solid state core to an electrical oscillating tank circuit FIG. 10 number 91 is the insulated electrical conducting wire that connects the inner solid state core to an electrical oscillation tank circuit FIG. 10 number 88 is the electrical insulator that separates the inner oscillating core to the outer oscillating core FIG. 10 number 99 is the solid state oscillating outer core FIG. 10 number 100 is the orientation of the oscillating electromagnetic wave produced by the solid state oscillator core 36 FIG. 10 number 89 is an insulated electrical conducting wire that connects the outer solid state core to an electrical oscillation tank circuit.

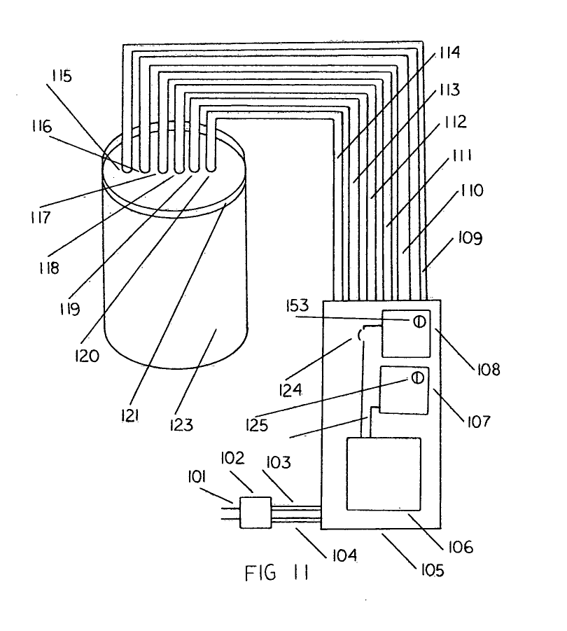

FIG. 11 is a perspective view of an overall construction of the cold fusion apparatus FIG. 11 number 101 is the electrical conductive wires that connect the power plug FIG. 11 number 102 to a power source FIG. 11 number 103 is the positive alternative current voltage insulated electrically conductive wire FIG. 11 number 104 is the alternative current voltage insulated electrical conductive wire FIG. 11 number 105 is the power supply assemble FIG. 11 number 106 is the power distribution module supplying power to the FIG. 11 number 107 1st oscillator 18 FIG. 11 number 108 is the 2nd oscillator FIG. 11 number 109 is the insulated electrical conductive wire connecting the 1st oscillator adjustable tank circuit to the outer inductor coil FIG. 111 number 110 is the insulated electrical conductive wire connected the 2nd oscillator adjustable tank circuit to the inner inductor coil FIG. 11 number 111 is the insulated electrical conductive wire connecting the cathode to the power supply assemble FIG. 11 number 105 FIG. 11 number 112 is the insulated electrical conductive wire connecting the anode to the power supply assemble FIG. 11 number 105 FIG. 11 number 113 is the insulated electrical conductive wire connecting the FIG. 11 number 2nd oscillator adjustable tank circuit to the inner inductor coil FIG. 11 number 114 is an insulated electrical conductive wire connecting the 1st oscillator 18 adjustable tank circuit to the outer inductor coil FIG. 11 number 115 is an hole in the FIG. 121 lid that is large enough to fit an wire though the hole and sung enough to provide isolation of the outside atmosphere air to the heavy water electrolyte solution FIG. 11 number 116 is an hole in the FIG. 121 lid that is large enough to fit an wire though the hole and sung enough to prove isolation of the outside atmosphere to the heavy water electrolyte solution FIG. 11 number 117 is an hole in the FIG. 121 lid that is large enough to fit an wire though the hole and sung enough to provide isolation of the outside atmosphere to the heavy water electrolyte solution FIG. 11 number 118 is an hole in the FIG. 121 lid that is large enough to fit an wire though the hole and sung enough to provide isolation of the outside atmosphere to the heavy water electrolyte solution FIG. 11 number 119 is an hold in the FIG. 121 lid that is large enough to fit an wire though the hole and sung enough to provide isolation of the outside atmosphere to the heavy water electrolyte solution FIG. 11 number 121 is an hold in the FIG. 121 lid that is large enough to fit an wire though the hole and sung enough to provide isolation of the outside atmosphere to the heavy water electrolyte solution FIG. 11 number 123 is the vessel that supports the lid and electrical wiring to support the components inside the vessel FIG. 1 number 124 is the adjustment that is part of the 2nd oscillator capacitors of the colpitts oscillator tank circuit FIG. 11 number 125 is the 1st adjustable oscillator tank circuit FIG. 11 number 153 is the switch that connects the power supply common ground to the 2nd oscillator tank circuit.

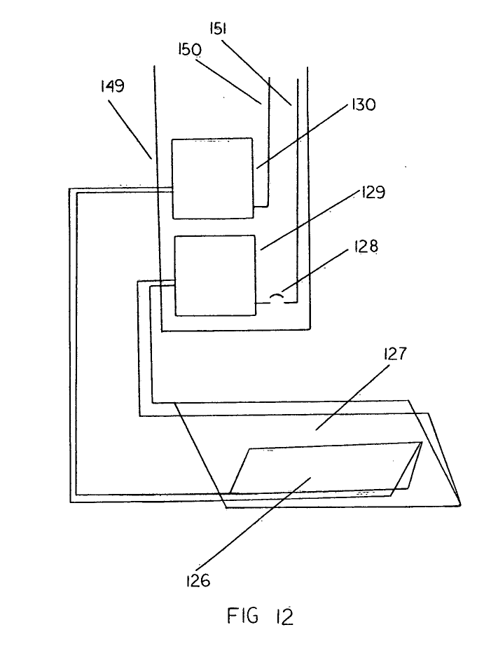

FIG. 12 is a perspective view of a fo the connection of the oscillator tank circuits to the inner and outer inductive coils FIG. 12 number 126 is an representation of the inner inductive coil FIG. 12 number 127 is an representation of the outer inductor coil FIG. 12 number 128 is the switch that gives common ground to the 2nd adjustable oscillator tank circuit FIG. 21 number 129 is the 2nd adjustable oscillator tanks circuit FIG. 12 number 130 is the 1st adjustable oscillator tank circuit FIG. 12 number 149 is the representation of the power supply assembly FIG. 12 number 150 is the common ground that connects to the FIG. 12 number 129 adjustable oscillator tank circuit FIG. 12 number 151 is the common ground that connects to the FIG. 12 number 130 adjustable oscillator tank circuit.

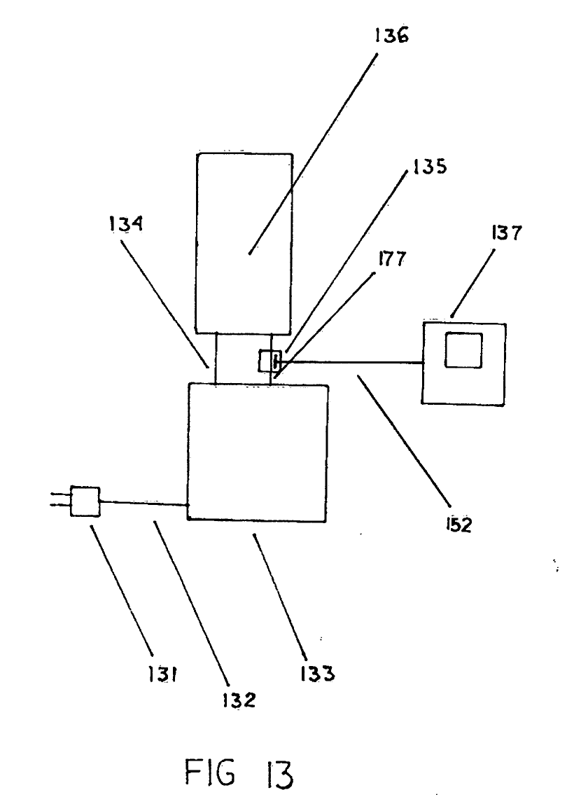

FIG. 13 is a perspective view of an of the complete setup to adjust the 1st and 2nd oscillator tank circuit FIG. 13 number 131 is the insulated electrical plug that connects the supplied power to the power supply assembly FIG. 13 number 133 FIG. 13 number 132 is the insulated electrical cord that supplies connectivity from the insulated electrical plug to the power supply assembly FIG. 13 number 133 FIG. 13 number 134 is the insulated electrical wire that connects the FIG. 13 number 133 power supply assembly to the anode in FIG. 13 number 136 vessel FIG. 13 number 135 is the tap component on the FIG. 13 number 177 electrical wire that connects the FIG. 13 number 133 power assembly 12 to the cathode in FIG. 13 number 136 vessel FIG. 132 number 137 is the oscillator scope that voltage measurement are taken off the tap circuit FIG. 13 number 135 tap.

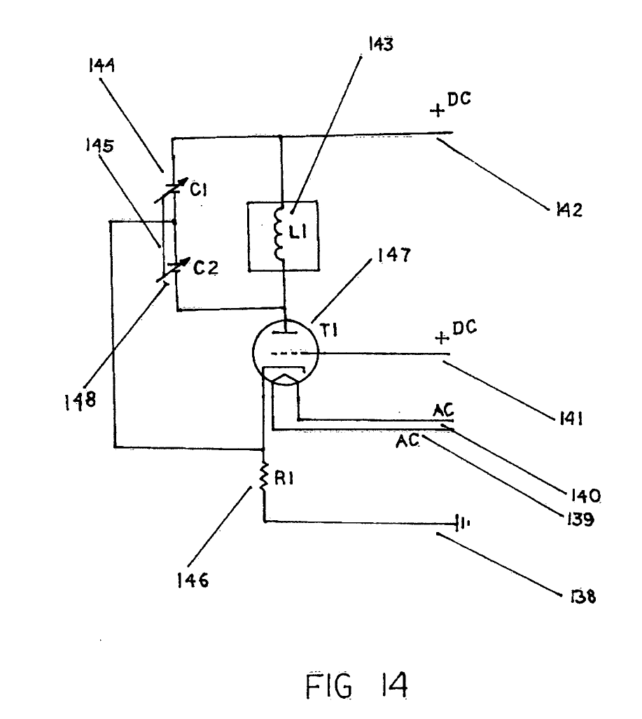

FIG. 14 is a perspective view of a 1st oscillator 18 colpitts circuit FIG. 14 number 138 is the common ground electrical connection that is supplied from the power supply FIG. 14 number 139 si the electrical connection that is supplied from the power supply ac circuit that provides energy to heat the filament in the FIG. 14 number 147 tube FIG. 14 number 140 is the electrical connection that is supplied from the power supply ac circuit that provide energy to heat the filament in the FIG. 14 number 147 tube FIG. 141 is the electrical connection that supplies a grid voltage from the power supply to the FIG. 14 number 147 tube FIG. 142 is the electrical connection that supplies a collector voltage to the tank circuit comprising the FIG. 14 number 143 inductor and the FIG. 14 number 144 c1 adjustable capacitor FIG. 14 number 143 is the inductor coil that is in the vessel contains the inductor coil FIG. 14 number 144 is an ganged adjustable tank circuit FIG. 14 number 145 is the device that connects the FIG. 14 number 144 capacitor tank circuit and FIG. 14 number 148 adjustable capacitor FIG. 14 number 147 is the triode tube FIG. 14 number 147.

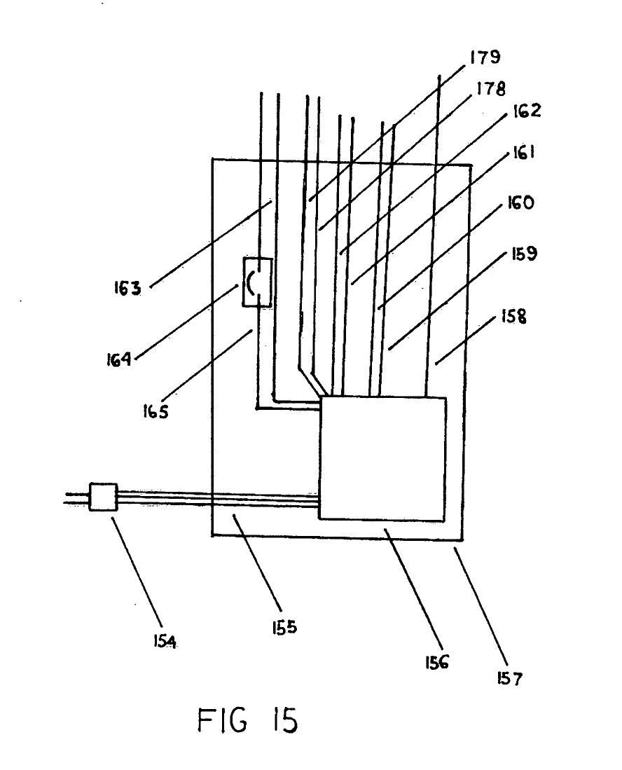

FIG. 15 is a perspective view of a power supply assembly FIG. 15 number 154 is the insulated electrical plug that connects outside supplied power to the FIG. 15 number 157 power supply assembly FIG. 15 number 155 is the electrical connection that connects the FIG. 15 number 154 electrical plus to the FIG. 15 number 156 power supply collector voltage to the 1st adjustable oscillator and 2nd adjustable oscillator FIG. 15 number 159 is the grid biasing voltage for the 2nd oscillator tube FIG. 15 number 161 is the electrical connection connecting the ac heater voltage to the 1st oscillator 18 tube FIG. 15 number 162 is the electrical connection connecting the ac heater voltage to the 1st oscillator 18 tube FIG. 15 number 178 is the electrical connection connecting the ac heater voltage to the 2nd oscillator tube FIG. 15 number 163 is the electrical connection connecting the common ground from the power supply FIG. 15 number 156 to the 1st oscillator 18 tank circuit FIG. 15 number 165 is the electrical connection connecting the common ground from the power supply from the power supply FIG. 15 number 156 to the 2nd oscillator tank circuit FIG. 15 number 164 is the switch that connects the electrical connection of the common ground to the 2nd oscillator tank circuit.

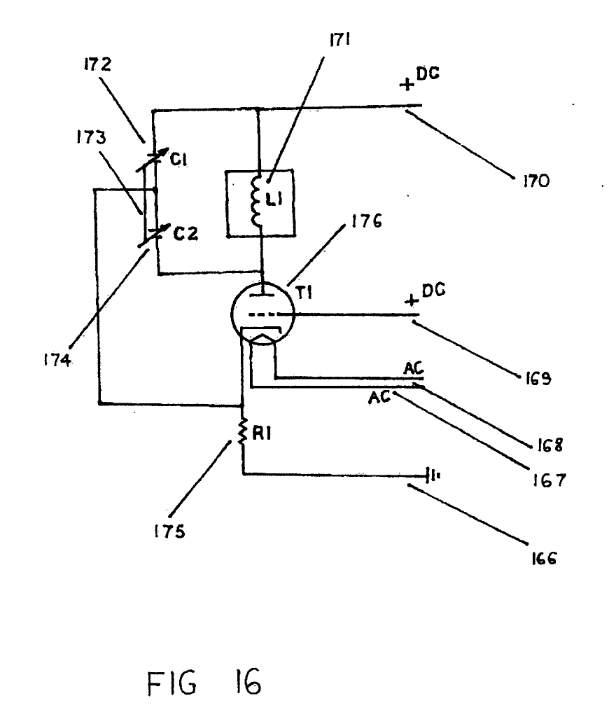

FIG. 16 is a perspective view of a 2nd oscillator colpitts circuit FIG. 16 number 166 is the common ground electrical connection that is supplied from the power supply FIG. 16 number 167 is the electrical connection that is supplied form the power supply ac circuit that provides energy to heat the filament in the FIG. 16 number 176 tube FIG. 16 number 168 is the electrical connection that is supplied from the power supply ac circuit that provide energy to heat the filament in the FIG. 16 number 176 tube FIG. 16 number 169 is the electrical connection that supplies a grid voltage from the power supply to the FIG. 16 number 176 tube FIG. 16 number 170 is the electrical connection that supplies a collector voltage to the tank circuit comprising the FIG. 16 number 171 inductor and the FIG. 16 number 172 c1 adjustable capacitor FIG. 16 number 171 is the inductor coil that is in the vessel that containing the inductor coil FIG. 16 number 172 is an ganged adjustable tank circuit FIG. 16 number 173 is the device that connects the FIG. 16 number 174 adjustable capacitor and FIG. 16 number 172 adjustable capacitor FIG. 16 number 176 is the triode tube FIG. 16 number 175 is the resistor that supplies voltage bias to the emitter grid of the FIG. 15 number 176 tube.

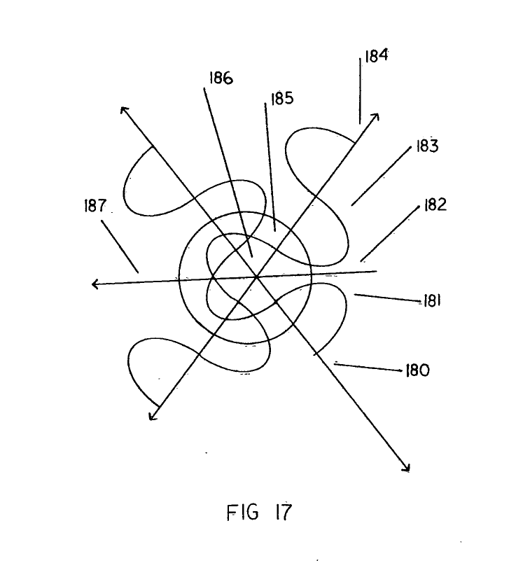

FIG. 17 which is a perspective view of the FIG. 17 number 180 is a line that shows the oscillation path of the 1st oscillator 18; also shows the propagation of the electromagnetic wave form positive and negative e field. FIG. 17 number 181 is the electromagnetic wave form peak positive waveform. FIG. 17 number 182 is the representation of the electrical current flow along the cathode of the palladium core. FIG. 17 number 183 shows the electromagnetic wave form negative e field of the 2nd oscillator path. FIG. 17 number 184 shows the oscillation path of the 2nd oscillator, also shows the propagation of the electromagnetic wave form. FIG. 17 number 185 shows the circular region of the intersection of the 1st oscillator 18 electromagnetic wave form and the 2nd oscillator electromagnetic wave form interactions when both electromagnetic waves forms are in the same oscillation frequency and the polarities allow the beginning of electromagnetic scalar wave production. FIG. 17 number 186 shows the 90 degree relationships between both electromagnetic fields and the polarizations of positive and negative waveforms allow the nullification effects to take place. FIG. 17 number 187 shows the direction of the electromagnetic current flow along the cathode core might not have been described.

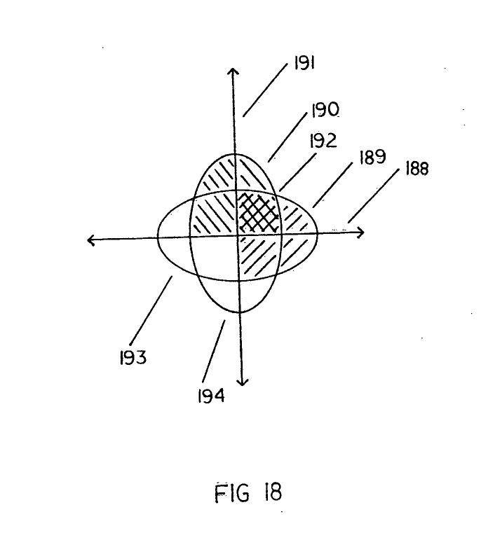

FIG. 18 which is a perspective view of the FIG. 18 number 193 shows the electromagnetic reconnection of the e field of both electromagnetic waves of the first oscillator and second oscillator electromagnetic wave form e fields negative region. FIG. 18 number 193 show the electromagnetic reconnection of the h field of both electromagnetic waves of the first oscillator and second oscillator electromagnetic wave form h field negative region. FIG. 18 number 189 of the shows the electromagnetic region of the e field of the 1st oscillator 18. FIG. 18 number 192 shows the 90 degree relationship intersection between both the 1st oscillator 18 and the second oscillator electromagnetic wave forms. FIG. 18 number 190 is the e field positive region. FIG. 18 number 191 shows the electromagnetic propagation directions. FIG. 18 number 188 shows the electromagnetic propagation directions.

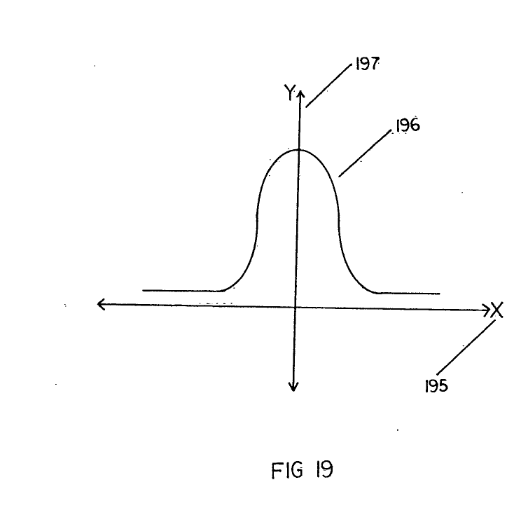

FIG. 19 which is a perspective view of the FIG. 19 number 195 is the x axis of the electromagnetic wave along the propagation wave path of a oscillator wave form. FIG. 19 number 196 shows the distribution of the e electromagnetic wave form in the oscillation wave. FIG. 19 number 190 shows the propagation of the acceleration of the electromagnetic wave form and maximum power of the oscillation wave form.

FIG. 20 which is a perspective view of the FIG. 20 number 198 is line FE=1/x2 the inverse square wave function of gravity in 3d space. FIG. 20 number 199 is the 12d space of gravity as it resides in inter-dimensional space. FIG. 20 number 200 is point B (+1,−1) and center of circle B, Circle B=propagation of gravity in region (+1,−1) with properties congruent to (+,−) on a coordinate graph as (+1,−1) FIG. 20 number 201 is the circular wave form of gravity as a engine of force. FIG. 20 number 202 is point E (+1,0) and is the intersection between photon or light and gravity FIG. 20 number 218 is the midpoint E of line AB. FIG. 20 number 203 is the x coordinate representation of 3d space and 12d space. FIG. 20 number 204 is the circular wave form of light as a engine of force. FIG. 20 number 205 is point A (+1,+1) and center of circle B, Circle B=propagation of photon or light in region (+1,−1) with properties congruent to (+,+) on a coordinate graph as (+1,+1) FIG. 20 number 206 is the 12d space of light as it reside in inter-dimensional space. FIG. 20 number 208 is the line HE=1/x2 the inverse square wave function of light in 3d space. FIG. 20 number 207 is the y coordinate representation of 3d space and 12d space. FIG. 20 number 219 is point H (0,+1) the intersection of photons or light and magnetism/electromagnetism. FIG. 20 number 209 is the line HG=1/x2 inverse square wave function of magnetism/electromagnetism in 3d space. FIG. 20 number 210 is the circular wave form of electromagnetic as a engine of force. FIG. 20 number 211 is point D (−1,+1) the center of circle D, Circle D=propagation of electromagnetism/magnetism in region (−1,+1) with properties congruent to (−1,+1) on a coordinate graph as (−1,+1) FIG. 20 number 212 is the 12d space of gravity as it reside inter-dimensional space. FIG. 20 number 220 is point G (−1,0) and is the intersection between electromagnetism/magnetism and time. FIG. 20 number 213 is point C (−1,−1) and center of circle C, Circle C=propagation of time in region (−1,−1), with properties congruent to (−1,−1) on a coordinate graph as (−1,−1) the center of the time center towards the circle of time propagation. FIG. 20 number 214 is the circular wave form of time as a engine of force. FIG. 20 number 215 is the 12d space of time as it resides in inter-dimensional space. FIG. 20 number 216 is the line FG=1/x2 inverse square eave function of time in 3d space. FIG. 20 number 221 is point (0,0) center of 3d space and is the (0,0) representation of a coordinate gird, with properties congruent to (+,+) in 3d space. FIG. 20 number 213 is also line CD with midpoint G at location (−1,0) FIG. 20 number 213 is also line CB with midpoint F at location (0,−1) FIG. 20 number 205 is also line AB with midpoint E at location (1,0) FIG. 20 number 205 is also line AD with midpoint H at location (0,+). FIG. 20 number 202 is also line EG with midpoint I at location (0,0). FIG. 20 number 217 is also line FH with midpoint I at location (0,0). FIG. 20 number 205 is also square ABCD and is the time frame of 3d space.

FIG. 21 number 222 is a palladium atom in a interstitial crystal structure. FIG. 21 number 223 is the representation of the repulsion of electric charge from the proton to proton and electron to electron repulsion. FIG. 21 number 224 is a palladium atom in a interstitial crystal structure. FIG. 21 number 225 is a deuterium atom in the palladium cage create from the static repulsion of electric charge. FIG. 21 number 226 is the representation of the repulsion of electric charge from the proton to proton and electron to electron repulsion. FIG. 21 number 227 is a palladium atom in a interstitial crystal structure. FIG. 21 number 228 is the representation of the repulsion of electric charge from the proton to proton and electron to electron repulsion. FIG. 211 number 229 shows the negative electron static repulsion FIG. 21 number 230 is a palladium atom in a interstitial crystal structure. FIG. 21 number 231 is the representation of the repulsion of the electric charge from the proton to proton and electron to electron repulsion. FIG. 21 number 232 is a deuterium atom in the palladium cage created from the repulsion of electric charge. FIG. 21 number 233 is the electromagnetic waveform from the 1st oscillator being injected into the electron repulsion cage. FIG. 21 number 234 is the electromagnetic waveform from the 2nd oscillator being injected into the electron repulsion cage, it also show the intersection of the 1st oscillator wave and the 2nd oscillator wave and the creation of electromagnetic scalar waves and the region that breaks down the 4d linear time frame into inter-dimensional base 12 circle time frame.

FIG. 22 which is a perspective view of the FIG. 22 number 235 is the mathematical relationship relating to gravity and magnetic with circle A light. FIG. 22 number 236 is the mathematical relationship relating to gravity and magnetic with circle C time. FIG. 22 number 237 is part of the complete formula in standard scientific notation and values with L representing light. FIG. 22 number 238 is part of the complete formula in standard scientific notation and values with T representing time. FIG. 22 number 239 is part of the complete formula in standard scientific notation and values with g representing gravity. FIG. 22 number 240 is part of the complete formula in standard scientific formula in standard scientific notation and values with B representing magnetic. FIG. 22 number 241 is light represented related to gravity and magnetic. FIG. 22 number 242 is time represented related to gravity and magnetic FIG. 22 number 243 is gravity FIG. 22 number 244 is magnetic represented related to gravity and magnetic FIG. 245 is D the circle that represents magnetic in standard scientific notations and values. FIG. 22 number 246 is circle B represents gravity in standard scientific notation and values. The mathematical relationship of FIG. 22 number 237 to FIG. 22 number 244 is the time frame in linear 3d space.

Having thus described the invention, what is desired to be protected by Letters Patent is presented in the subsequently appended claims.

What is claimed is:

1. A cold fusion apparatus for to generate excess heat energy via the process of cold fusion comprising:
means for supply power to the cold fusion apparatus;
means for supply voltages for the oscillators and anode and cathode, rigidly connected to said means for supply power to the cold fusion apparatus;
means for compression of deuterium atom in a crystalline interstitial structure element, rigidly connected to said means for supply voltages for the oscillators and anode and cathode;
means for electrolyte reactions with heavy water and chemical reactions to create a electrolytic heavy water circuit, rigidly connected to said means for supply voltages for the oscillators and anode and cathode;
means for creation of an electromagnetic field that is to resonate with the cathode, rigidly connected to said means for supply voltages for the oscillators and anode and cathode;
means for creation of electromagnetic scalar wave with the 1st oscillator, rigidly connected to said means for supply voltages for the oscillators and anode and cathode;
means for chemical reaction solution with heavy water, rigidly connected to said means for electrolyte reactions with heavy water and chemical reactions to create a electrolytic heavy water circuit, and rigidly connected to said means for compression of deuterium atom in a crystalline interstitial structure element;
means for containment of electrolyte solution
anode cathode outer inductive coil inner inductive coil, rigidly connected to said means for chemical reaction solution with heavy water, rigidly connected to said means for creation of electromagnetic scalar wave with the 1st oscillator, rigidly connected to; said means for creation of an electromagnetic field that is to resonate with the cathode, rigidly
connected to said means for electrolyte reactions with a heavy water and chemical reactions to create a electrolytic heavy water circuit, and rigidly connected to said means for compression of deuterium atom in a crystalline interstitial structure element;
means for altering 3d plus linear time with electromagnetic oscillations, vibrations, scalar wave creation, altering linear time into circular time.

2. The cold fusion apparatus in accordance with claim 1, wherein said means for supply power to the cold fusion apparatus comprises a power supply.

3. The cold fusion apparatus in accordance with claim 1, wherein said means for supply voltages for the oscillators and anode and cathode comprises a power assembly.

4. The cold fusion apparatus in accordance with claim 1, wherein said means for compression of deuterium atom in a crystalline interstitial structure element comprises a cathode.

5. The cold fusion apparatus in accordance with claim 1, wherein said means for electrolyte reactions with heavy water and chemical reactions to create a electrolytic heavy; water circuit comprises an anode.

6. The cold fusion apparatus in accordance with claim 1, wherein said means for creation of an electromagnetic field that is to resonate with the cathode comprises a 1st oscillator.

7. The cold fusion apparatus in accordance with claim 1, wherein said means for creation of electromagnetic scalar wave with the 1st oscillator comprises a 2nd oscillator.

8. The cold fusion apparatus in accordance with claim 1, wherein said means for chemical reaction solution with; heavy water comprises an electrolyte.

9. The cold fusion apparatus in accordance with claim 1, wherein said means for containment of electrolyte solution anode cathode outer inductive coil inner inductive coil comprises a vessel.

10. The cold fusion apparatus in accordance with claim 1, wherein said means for changing linear time into circle time comprises an timeframe change.

11. A cold fusion apparatus for to generate excess heat energy via the process of cold fusion comprising:
a power supply, for supply power to the cold fusion apparatus; a power assembly, for supply voltages for the oscillators and anode and cathode, rigidly connected to said power supply;
a cathode, for compression of deuterium atom in a crystalline interstitial structure element, rigidly connected to said power assembly;
an anode, for electrolyte reactions with heavy t water and chemical reactions to create a electrolytic heavy water circuit, rigidly connected to said power assembly; a 1st oscillator, for creation of an electromagnetic field that is to resonate with the cathode, rigidly connected to said power assembly;
a 2nd oscillator, for creation of electromagnetic scalar wave with the 1^{st} oscillator rigidly connected to said power assembly;
an electrolyte, for chemical reaction solution with heavy water, rigidly connected to said anode, and rigidly connect to said cathode; and
a vessel, for containment of electrolyte solution anode cathode outer inductive coil inner inductive coil, rigidly connected to said electrolyte, rigidly connected to said 2^{nd} oscillator, rigidly connected to said 1st oscillator, rigidly connected to said anode, and rigidly connected to said cathode; altering 3d plus linear time with electromagnetic oscillations, vibrations, scalar wave creation, altering linear time into circular time.
